(19) United States
(12) Patent Application Publication
(10) Pub. No.: US 2026/0298330 A1
(43) Pub. Date: Oct. 1, 2026

(54) PLANETARY GEAR MECHANISM

(71) Applicant: HONDA MOTOR CO., LTD., Tokyo (JP)

(72) Inventor: Ryuzaburo KOBAYASHI, Saitama (JP)

(21) Appl. No.: 19/442,086

(22) Filed: Jan. 7, 2026

(30) Foreign Application Priority Data
Mar. 28, 2025 (JP) 2025-055574

(51) Int. Cl. F16H 57/04; F16H 1/28; F16H 57/08

(52) U.S. Cl. CPC F16H 57/043; F16H 1/28; F16H 57/0471; F16H 57/0486; F16H 57/082; F16H 2057/085

(57) ABSTRACT

A planetary gear mechanism includes: a sun gear; a plurality of planetary gears; a ring gear; and a planetary carrier. The planetary carrier includes: a main body; a plurality of support shafts supporting the plurality of planetary gears; and a bearing provided between each of the plurality of support shafts and the corresponding planetary gear. The bearing includes: at least one inner ring; an outer ring; a plurality of rolling elements; and an oil introduction hole penetrating the inner ring in a radial direction. Each of the plurality of support shafts includes: a through hole penetrating the planetary carrier; an oil discharge hole extending from an inner circumferential surface of the through hole to an outer circumferential surface of the support shaft; and an oil guide portion provided on the inner circumferential surface of the through hole and configured to guide a lubricating oil to the oil discharge hole.

### TECHNICAL FIELD

The present invention relates to a planetary gear mechanism.

### BACKGROUND ART

In recent years, efforts to realize a low-carbon or carbon-free society have been gaining momentum, and research and development of electrification technologies is being conducted for vehicles, aircraft, and the like to reduce CO2 emissions and improve energy efficiency.

In the aircraft, a planetary gear mechanism connected to a shaft to which a rotor is coupled is employed. The planetary gear mechanism includes a sun gear, a plurality of planetary gears meshed with the sun gear, a planetary carrier rotatably supporting the plurality of planetary gears, and the ring gear meshed with the plurality of planetary gears. There is a technique for lubricating the planetary gear mechanism used in an output portion of a turbofan engine. For example, in the planetary gear mechanism described in JP6356757B, the planetary carrier includes a hollow cylindrical support pin that extends in an axial direction of the planetary gear. A cylindrical inner ring that is non-rotatably connected to an outer surface of the support pin and a plurality of rollers that are rotatably arranged on an outer circumference of the inner ring are provided between the support pin and the planetary gear.

To circulate a lubricating oil from an inner circumferential surface of the support pin to the roller to lubricate the roller, the support pin is provided with a plurality of oil feed holes and interconnected grooves, and the inner ring is provided with a plurality of passages. The plurality of oil feed holes penetrates the support pin radially. The interconnected grooves are provided on an outer circumferential surface of the support pin and intersect with the plurality of oil feed holes. The plurality of passages intersects the interconnected grooves and penetrates the inner ring.

The lubricating oil flows from the inner circumferential surface of the support pin into the oil feed hole. The lubricating oil flows from the oil feed holes on the support pin to the interconnected grooves, and then from the interconnected grooves to the oil feed holes that penetrate the inner ring. The lubricating oil then flows out from the oil feed holes to the outer circumferential surface of the inner ring. This allows the lubricating oil to be supplied to the roller on the outer circumference of the inner ring, lubricating the roller.

In the planetary gear mechanism described in JP6356757B, the interconnected grooves extend along the outer circumferential surface of the support pin in a direction that intersects the radial direction of the support pin. Since the interconnected grooves may create resistance to a flow of the lubricating oil, there is a possibility that an insufficient amount of the lubricating oil is supplied to the roller. Further, JP6356757B does not disclose how the lubricating oil is fed under pressure into the hollow support pin and guided to the oil feed hole. Since the insufficient amount of the lubricating oil flows into the oil feed hole from inside the support pin, the roller may not be sufficiently lubricated. Accordingly, the technique disclosed in JP6356757B may not be able to sufficiently lubricate a gap between the planetary carrier and the planetary gear.

### SUMMARY OF THE INVENTION

In view of the above background, an object of the present invention is to provide a planetary gear mechanism that can easily lubricate a gap between a planetary carrier and a planetary gear with a lubricating oil. This in turn contributes to improving energy efficiency.

To achieve such an object, one aspect of the present invention provides a planetary gear mechanism including: a sun gear coupled to an input shaft extending in an axial direction; a plurality of planetary gears meshed with the sun gear; a ring gear supported by a case and meshed with the plurality of planetary gears; and a planetary carrier rotatably supporting the plurality of planetary gears and coupled to an output shaft extending coaxially with the input shaft. The planetary carrier includes: a main body connected to the output shaft; a plurality of support shafts provided on the main body and supporting the plurality of planetary gears; and a bearing provided between each of the plurality of support shafts and the corresponding planetary gear. The bearing includes: at least one inner ring fixed to the support shaft; an outer ring fixed to the planetary gear; a plurality of rolling elements arranged between the inner ring and the outer ring; and an oil introduction hole penetrating the inner ring in a radial direction of the support shaft. Each of the plurality of support shafts includes: a through hole penetrating the planetary carrier along an axis of the support shaft; an oil discharge hole formed in a radially outer portion of the planetary carrier and extending from an inner circumferential surface of the through hole to an outer circumferential surface of the support shaft; and an oil guide portion provided on the inner circumferential surface of the through hole and configured to guide a lubricating oil that flows into the through hole to the oil discharge hole.

According to this aspect, the lubricating oil that flows into the through hole is guided to the oil discharge hole by the oil guide portion, flows through the oil discharge hole and the oil introduction hole of the bearing, and flows out into a space between the inner ring and the outer ring of the bearing. Accordingly, the bearing is lubricated by the lubricating oil. Here, the oil guide portion guides the lubricating oil to the oil discharge hole, so that the lubricating oil that flows into the through hole can readily flow into the oil discharge hole. This allows a gap between the planetary carrier and the planetary gear to be easily lubricated by the lubricating oil. Accordingly, it is possible to provide the planetary gear mechanism in which the gap between the planetary carrier and the planetary gear can be easily lubricated by the lubricating oil.

Thus, according to the above aspects, it is possible to provide the planetary gear mechanism that can easily lubricate the gap between the planetary carrier and the planetary gear with the lubricating oil.

### BRIEF DESCRIPTION OF THE DRAWING

FIG. 1 is a perspective view of an aircraft according to an embodiment of the present invention;

FIG. 2 is a perspective view of a base and an electric drive device;

FIG. 3 is a cross-sectional view of the electric drive device;

FIG. 4 is a perspective view of a reduction gear;

FIG. 5 is an exploded perspective view of the reduction gear;

FIG. 6 is a cross-sectional view of a support shaft and a planetary gear;

FIG. 7 is a cross-sectional view of a tubular member;

FIG. 8 is a cross-sectional view of the tubular member according to a second embodiment of the present invention;

FIG. 9 is a cross-sectional view of the tubular member according to a third embodiment of the present invention;

FIG. 10 is a cross-sectional view of the tubular member according to a fourth embodiment of the present invention;

FIG. 11 is a cross-sectional view of the tubular member according to a fifth embodiment of the present invention; and

FIG. 12 is a cross-sectional view of the tubular member of a sixth embodiment of the present invention.

### DETAILED DESCRIPTION OF THE INVENTION

### First Embodiment

### An aircraft 1

In the following, an aircraft 1 according to a first embodiment of the present invention will be described with reference to the drawings. In the drawings and the following description, directions such as forward, rearward, left, right, up, and down are directions defined relative to the aircraft 1.

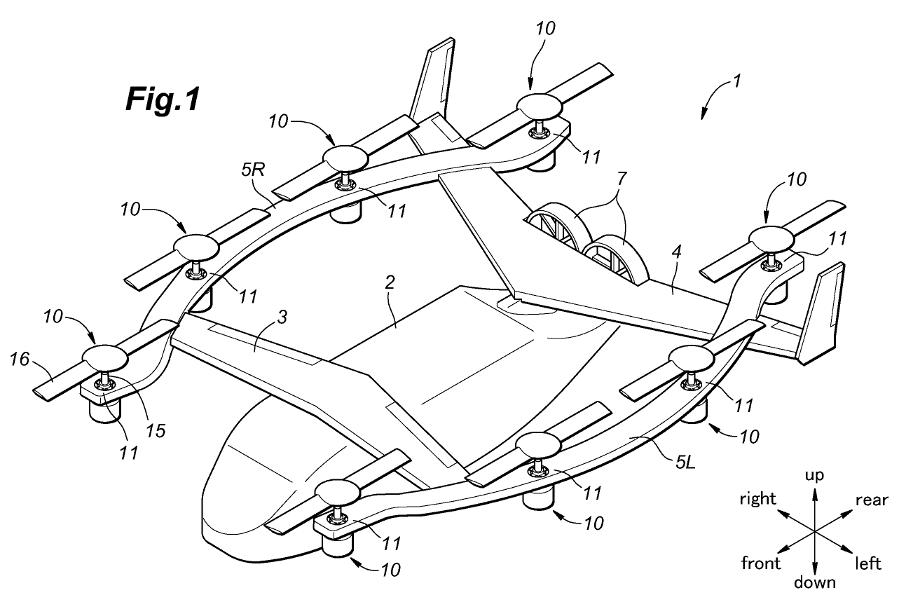

FIG. 1 is a perspective view showing the aircraft 1 according to the first embodiment. As shown in FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4. The front wing 3 and the rear wing 4 are formed in a shape that generates a lifting force when moving forward.

A cabin (not shown) for an occupant to board is provided in the front portion of the body 2. Left and right rear propulsion force generators 7 for applying the forward propulsion force to the aircraft 1 are provided at the rear end of the body 2.

The left arm 5L and the right arm 5R are each provided with a plurality of (for example, four) electric drive devices 10 at intervals in the front-and-rear direction. Each electric drive device 10 applies ascending and descending forces to the aircraft 1. The left arm 5L and the right arm 5R are provided with a plurality of bases 11, each provided with an electric drive device 10.

Each base 11 has the same configuration. Further, each electric drive device 10 has the same configuration. One electric drive device 10 will be described below.

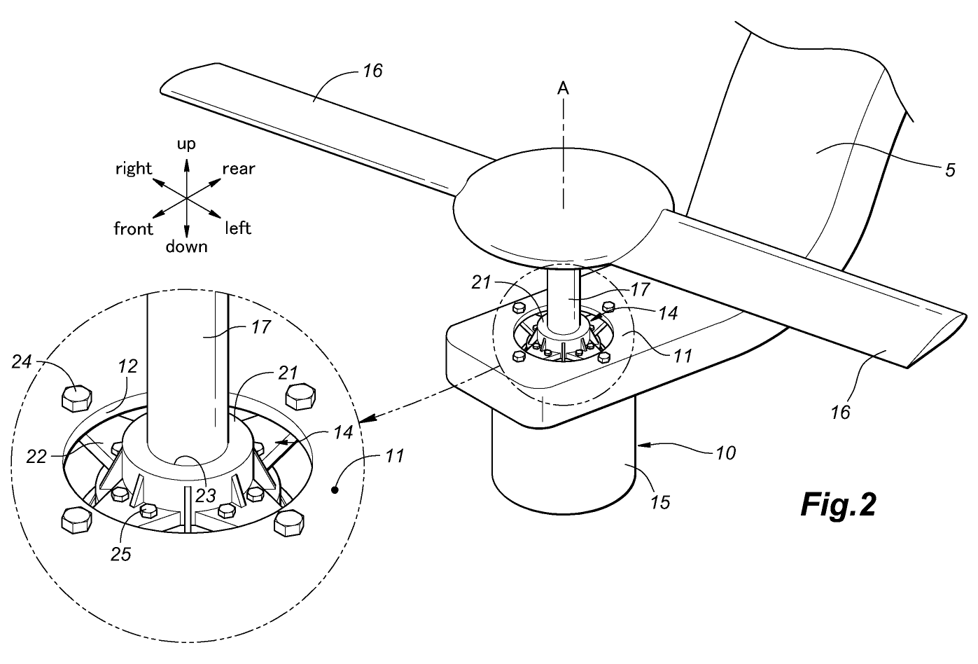

FIG. 2 is a perspective view of the base 11 and the electric drive device 10. As shown in FIG. 2, the bases 11 are provided on the left arm 5L and the right arm 5R, and formed in a plate shape. The base 11 includes an attachment hole 12 extending in the up-and-down direction. The attachment hole 12 is a circular hole. A support portion is removably attached to the base 11. The electric drive device 10 is attached to the base 11 via the support portion 14.

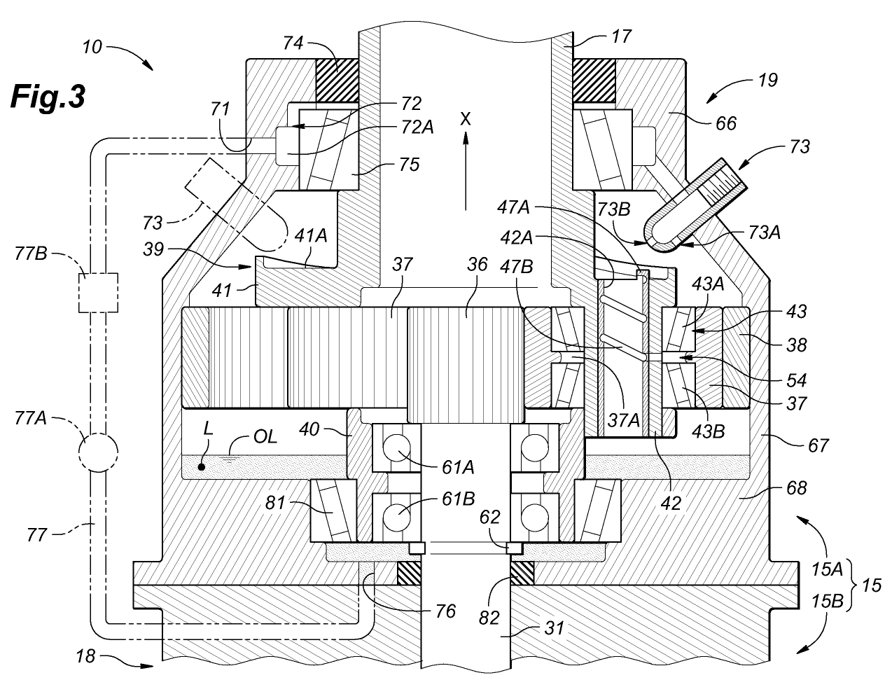

Each electric drive device 10 includes a case 15, an output shaft 17 extending in the up-and-down direction and having a rotor 16 fixed to the upper end (one end) thereof, an electric motor 18 (see FIG. 3) accommodated in a case 15, and a reduction gear 19 (see FIG. 3) accommodated in a case 15 and transmitting a driving force of the electric motor 18 to the output shaft 17.

The support portion 14 includes a tubular main body 21 that rotatably supports the output shaft 17, and four arm portions 22 that extend radially outward from the main body 21. The main body 21 is formed in a cylindrical shape that extends in the up-and-down direction. The main body 21 is provided with a bearing hole 23 extending vertically through the center thereof. The bearing hole 23 is provided with the bearing (not shown). The output shaft 17 is rotatably supported in the bearing hole 23 via the bearing.

Four arm portions 22 extend radially from the lower end of the main body 21. Each arm portion 22 is connected to the main body 21. Each arm portion 22 is fastened to the base 11 by the fastener 24, such as a bolt and nut. Accordingly, the main body 21 is supported by the base 11 via a plurality of arm portions 22. Each arm portion 22 is fastened to the case 15 by a fastener 25, such as a bolt and nut. Accordingly, the electric drive device 10 is fixed to the base 11 via the arm portion 22. Each electric drive device 10 rotates the rotor 16 together with the output shaft 17 to apply the ascending and descending forces to the aircraft 1.

FIG. 3 is a schematic cross-sectional view of the electric drive device 10. As shown in FIG. 3, the electric drive device 10 includes the electric motor 18 and the reduction gear 19 connected to the electric motor 18 and the output shaft 17. The case 15 of the electric drive device 10 includes a cylindrical case 15A that accommodates the reduction gear 19, and a cylindrical case 15B that accommodates the electric motor 18. The driving force of the electric motor 18 is transmitted to an input shaft 31 of the reduction gear 19. The rotation shaft of the electric motor 18 may be formed integrally with the input shaft 31 of the reduction gear 19 or may be formed separately.

### the reduction gear 19

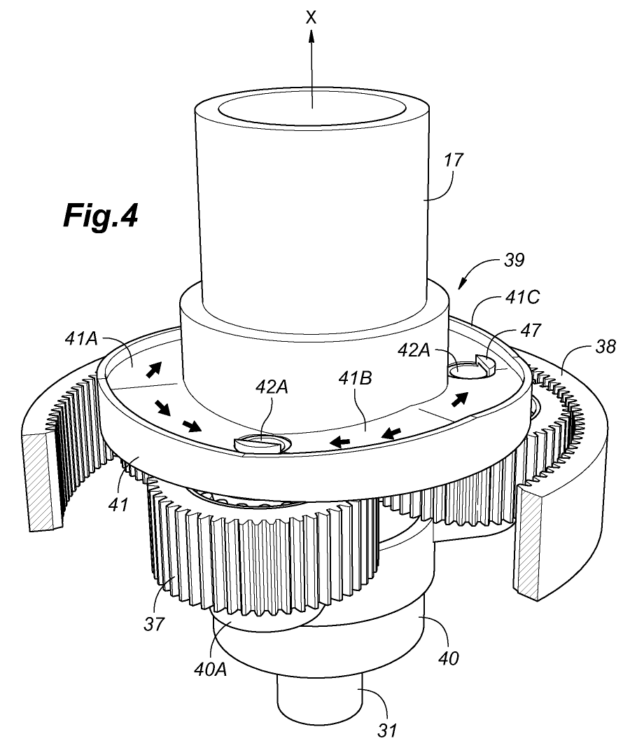

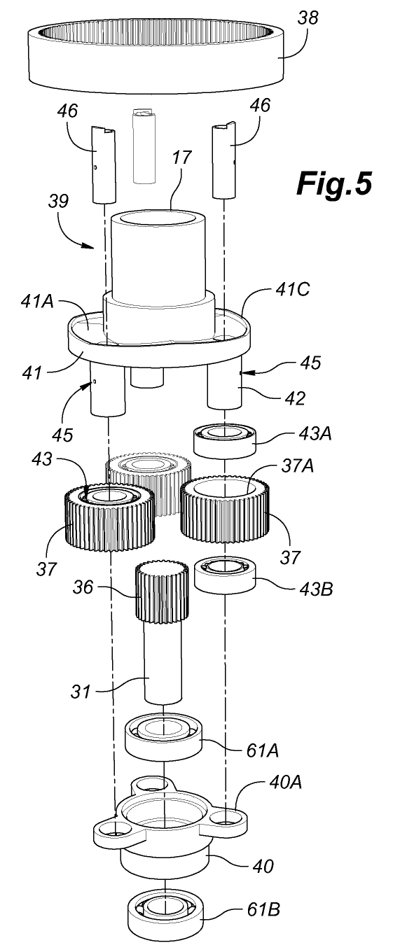

FIG. 4 is a perspective view of the reduction gear 19. FIG. 5 is an exploded perspective view of the reduction gear 19. As shown in FIGS. 3 to 5, the input shaft 31 of the reduction gear 19 is formed in a cylindrical shape. The output shaft of the reduction gear 19 is the output shaft 17. The output shaft 17 is formed in a tubular shape. The output shaft 17 and the input shaft 31 are coaxial, extend in an axial direction X, and rotate about the axial direction X.

As shown in FIGS. 3 to 5, the reduction gear 19 is a planetary gear mechanism. The reduction gear 19 includes a sun gear 36 coupled to the input shaft 31 extending in the axial direction X, a plurality of planetary gears 37 meshed with the sun gear 36, a ring gear 38 meshed with the plurality of planetary gears 37, a planetary carrier 39 rotatably supporting the plurality of planetary gears 37 and coupled to the output shaft 17, and a support member 40 rotatably supporting the planetary carrier 39. There is no limitation on the number of planetary gears 37. For example, the number of planetary gears 37 may be four.

The sun gear 36 is a spur gear coaxial with the input shaft 31. The sun gear 36 is formed integrally with the input shaft 31. The sun gear 36 may be a helical gear.

Each planetary gear 37 is a spur gear formed in a cylindrical shape extending in the axial direction X. Each planetary gear 37 may be a helical gear. Each planetary gear 37 includes a through hole 37A. The ring gear 38 is arranged coaxially with the input shaft 31, the output shaft 17, and the sun gear 36. As shown in FIG. 3, the ring gear 38 is coupled to the inner circumferential surface of the case 15A. Accordingly, the ring gear 38 is supported by the case 15A.

As shown in FIGS. 3 and 5, the planetary carrier 39 includes a main body 41 connected to the output shaft 17, a plurality of support shafts 42 provided on the main body 41 and supporting a plurality of planetary gears 37, and a bearing 43 provided between each of the support shafts 42 and the corresponding planetary gear 37.

The main body 41 is formed in a disk shape extending radially about the output shaft 17 and having the surface facing in the up-and-down direction. As shown in FIG. 4, an upper surface 41A of the main body 41 is provided with an inclined surface 41B inclined toward the support shaft 42 in the circumferential direction and downward (from the main body 41 side toward the opposite side of the support shaft 42), and a circumferential wall 41C protruding upward (to the opposite side of the support shaft 42) from the upper surface 41A at the radially outer end and extending in the circumferential direction.

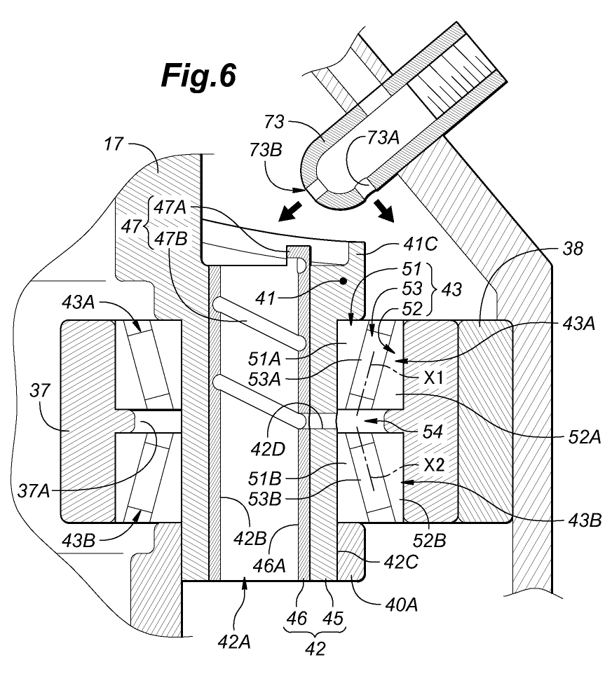

FIG. 6 is a cross-sectional view of the support shaft 42 and the planetary gear 37 of the planetary carrier 39. As shown in FIGS. 4 and 6, each of the support shafts 42 includes a support shaft main body 45 extending downward from the main body 41 and a tubular member 46 inserted into the through hole of the support shaft main body 45. The support shaft main body 45 and the tubular member 46 are arranged coaxially.

As shown in FIG. 6, each of the support shafts 42 includes a through hole 42A penetrating the planetary carrier 39 along the axis of the support shaft 42, an oil discharge hole 42D extending from an inner circumferential surface 42B of the through hole 42A to an outer circumferential surface 42C of the support shaft 42, and an oil guide portion 47 provided on the inner circumferential surface 42B of the through hole 42A and configured to guide the lubricating oil L that flows into the through hole 42A to the oil discharge hole 42D.

An inner circumferential surface 46A of the tubular member 46 defines the inner circumferential surface 42B of the through hole 42A. The outer circumferential surface 42C of the support shaft 42 is the same as the outer circumferential surface of the support shaft main body 45. The oil discharge hole 42D is a through hole penetrating the support shaft main body 45 and the tubular member 46. The oil discharge hole 42D is formed in the radially outer portion of the planetary carrier 39. The oil guide portion 47 is provided on the inner circumferential surface 46A of the tubular member 46.

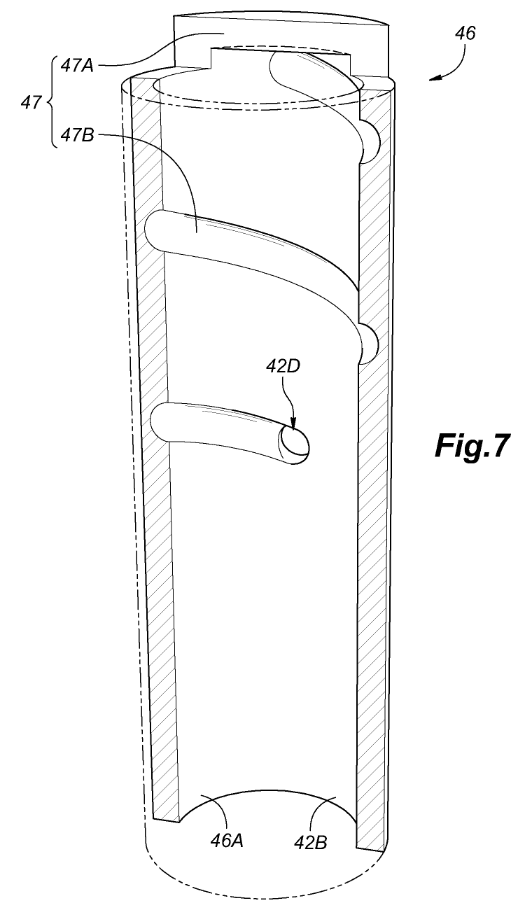

FIG. 7 is a cross-sectional view of the tubular member 46. As shown in FIG. 7, the oil guide portion 47 according to the present embodiment includes, on the inner circumferential surface 46A of the tubular member 46 (the inner circumferential surface 42B of the through hole 42A), an oil catch portion 47A protruding radially inward at the upper end, and a helical groove 47B extending from the upper end (one end) to the oil discharge hole 42D.

As shown in FIG. 6, the oil catch portion 47A is formed in the radially outer portion of the planetary carrier 39 on the inner circumferential surface 46A of the tubular member 46 (the inner circumferential surface 42B of the through hole 42A). The oil catch portion 47A protrudes radially inward at the upper end (one end) on the main body 41 side and extends in the circumferential direction.

As shown in FIG. 7, on the inner circumferential surface 46A of the tubular member 46 (the inner circumferential surface 42B of the through hole 42A), the helical groove 47B extends helically about the central axis of the through hole 42A from the upper end (one end) on the main body 41 side to the oil discharge hole 42D.

As shown in FIG. 6, the bearing 43 is provided in the through hole 37A of the planetary gear 37. The bearing 43 includes an inner ring 51 fixed to the support shaft 42 (the support shaft main body 45), an outer ring 52 (double-row outer ring) fixed to the planetary gear 37, a plurality of rolling elements 53 arranged between the inner ring 51 and the outer ring 52, a retainer (not shown) that supports the plurality of rolling elements 53, and an oil introduction hole 54 penetrating the inner ring 51 in a radial direction of the support shaft 42.

The bearing 43 includes, as the inner rings 51, a first single-row inner ring 51A and a second single-row inner ring 51B that are fixed to the support shaft 42 (the support shaft main body 45) and are aligned in the axial direction X. The first single-row inner ring 51A is arranged on the main body 41 side of the second single-row inner ring 51B. The bearing 43 includes, as the outer rings 52, a first single-row outer ring 52A and a second single-row outer ring 52B that are fixed to the planetary gear 37 and aligned in the axial direction X. The first single-row outer ring 52A corresponds to the first single-row inner ring A. The second single-row outer ring 52B corresponds to the second single-row inner ring 51B.

The bearing 43 includes, as a plurality of rolling elements 53, a plurality of first tapered rollers 53A which are a plurality of rolling elements (the first rolling elements) arranged between the first single-row inner ring 51A and the first single-row outer ring 52A, and a plurality of second tapered rollers 53B which are a plurality of rolling elements (the second rolling elements) arranged between the second single-row inner ring 51B and the second single-row outer ring 52B.

The first tapered roller 53A rotates about the first rotation axis that is inclined radially outward of the support shaft 42 from one end of the first tapered roller 53A on the oil introduction hole 54 side to the other end thereof. The first rotation axis is inclined radially outward of the support shaft 42 toward the upper side (one end side) of the support shaft 42. The second tapered roller 53B rotates about the second rotation axis that is inclined radially outward of the support shaft 42 from one end of the second tapered roller 53B on the oil introduction hole 54 side to the other end thereof. The second rotation axis is inclined radially outward of the support shaft 42 toward the lower side (the other end side) of the support shaft 42.

As shown in FIGS. 5 and 6, the bearing 43 includes a first bearing 43A including the first single-row inner ring 51A, the first single-row outer ring 52A, and a plurality of first tapered rollers 53A, and a second bearing 43B including the second single-row inner ring 51B, the second single-row outer ring 52B, and a plurality of second tapered rollers 53B.

The oil introduction hole 54 is formed between the first single-row inner ring 51A and the second single-row inner ring 51B.

As shown in FIGS. 3 and 5, the support member 40 is formed in a tubular shape that surrounds the outer circumference of the input shaft 31. As shown in FIGS. 5 and 6, an upper end 40A of the support member 40 is connected to each of the support shafts 42 and supports each of the support shafts 42 from below. As shown in FIGS. 3 and 5, bearings 61A and 61B are provided between the support member 40 and the input shaft 31. As shown in FIG. 3, a retaining ring 62 is attached to a groove formed on the outer circumferential surface of a lower end of the input shaft 31. The retaining ring 62 supports the bearing 61B from below. The bearings 61A and 61B are preferably capable of supporting radial loads and axial loads. The bearings 61A and 61B may be, for example, tapered roller bearings or angular contact ball bearings.

The case 15A is formed in a cylindrical shape. The case 15A includes an upper wall 66 through which the output shaft 17 is inserted, sidewalls 67 extending downward from the upper wall 66, and a bottom wall 68 coupled to the sidewalls 67.

The upper wall 66 is formed to have a reduced diameter toward the top. The upper wall 66 is provided with an inflow hole 71 penetrating the upper wall 66 radially, an oil passage 72 connected to the inflow hole 71, and a plurality of oil jets 73 connected to the oil passage 72. An oil seal 74 and a bearing 75 that rotatably supports the output shaft 17 are provided between the upper wall 66 and the output shaft 17. The bearing 75 is arranged below the oil seal 74. The bearing 75 is preferably a tapered roller bearing.

The oil passage 72 is connected to the inflow hole 71, the bearing 75, and a plurality of oil jets 73, and includes an annular passage 72A that extends circumferentially inside the upper wall 66. In the present embodiment, the upper wall 66 is provided with two oil jets 73 arranged opposite to each other. The number and arrangement of the oil jets 73 may be changed.

Each oil jet 73 includes an injection port 73A that injects the lubricating oil L toward the upper end of the ring gear 38 and an injection port 73B that injects the lubricating oil L toward the upper surface 41A of the main body 41 of the planetary carrier 39. In FIG. 6, the directions in which the lubricating oil L is injected from the injection ports 73A and 73B are indicated by solid black arrows.

The ring gear 38 is coupled to the inner surface of the sidewall 67. The lubricating oil L is stored at the bottom of the case 15A.

The bottom wall 68 includes an outflow hole 76, with the input shaft 31 inserted through the bottom wall 68, and is provided with a bearing 81 that rotatably supports the support member 40. An oil seal 82 is provided between the bottom wall 68 and the input shaft 31. The bearing 81 is preferably a tapered roller bearing.

The outflow hole 76 is arranged below an oil level OL of the lubricating oil L stored at the bottom of the case 15A. An oil piping 77 is connected to the outflow hole 76 and the inflow hole 71. The oil piping 77 includes a pump 77A that pumps the lubricating oil L flowing through the oil piping 77 from the outflow hole 76 to the inflow hole 71, and a heat exchanger 77B that cools the lubricating oil L.

### transmission of driving force in the reduction gear 19

As shown in FIGS. 3 to 5, when the driving force of the electric motor 18 is transmitted to the input shaft 31, the sun gear 36 provided on the outer circumference of the input shaft 31 rotates together with the input shaft 31. As the sun gear 36 rotates, the three planetary gears 37 that are meshed with the sun gear 36 and the ring gear 38 rotate about the axes and revolve around the outer circumference of the sun gear 36. Accordingly, the planetary carrier 39 rotates together with the output shaft 17 about the axis of the output shaft 17. Accordingly, the output torque of the electric motor 18 is decelerated and transmitted to the output shaft 17. As shown in FIG. 2, the output shaft 17 rotates together with the rotor 16 and applies the ascending and descending forces to the aircraft 1.

### lubrication of the reduction gear 19 by the lubricating oil L

As shown in FIG. 3, the lubricating oil L stored at the bottom of the case 15A is pumped from the outflow hole 76 to the inflow hole 71 by the pump 77A. The lubricating oil L flows from the inflow hole 71 into the oil passage 72. The lubricating oil L flows from the oil passage 72 into the annular passage 72A. The lubricating oil L flows from the annular passage 72A into the bearing 75 to lubricate the bearing 75. The lubricating oil L flows from the annular passage 72A to the plurality of oil jets 73. Each oil jet 73 injects the lubricating oil L from the injection port 73A toward the upper end of the ring gear 38 and from the injection port 73B toward the upper surface 41A of the main body 41 of the planetary carrier 39.

The lubricating oil L injected from the injection port 73A adheres to the ring gear 38. The lubricating oil L then adheres to the planetary gear 37 that is meshed with the ring gear 38. Further, the lubricating oil L adhered to the planetary gear 37 also adheres to the sun gear 36 that is meshed with the planetary gear 37. In this manner, the sun gear 36, the planetary gear 37, and the ring gear 38 are lubricated by the lubricating oil L injected from the injection port 73B. The lubricating oil L then drips and is stored at the bottom of the case 15A.

The lubricating oil L injected from the injection port 73B adheres to the upper surface 41A of the main body 41 of the planetary carrier 39. The lubricating oil L flows from the upper surface 41A of the main body 41 into the through hole 42A of the support shaft 42. As shown in FIG. 4, the upper surface 41A of the main body 41 is provided with the inclined surface 41B and the circumferential wall 41C.

As shown in FIG. 4, the inclined surface 41B is inclined toward the support shaft 42 in the circumferential direction and downward (from the main body 41 side toward the opposite side of the support shaft 42). Accordingly, as indicated by the arrows in FIG. 4, the lubricating oil L readily flows into the through hole 42A of the support shaft 42 along the inclined surface 41B due to the inclination of the inclined surface 41B.

The circumferential wall 41C protrudes upward (to the opposite side of the support shaft 42) from the upper surface 41A and extends circumferentially. Since the main body 41 rotates, the lubricating oil L adhered to the upper surface 41A is subjected to a centrifugal force acting radially outward. The circumferential wall 41C blocks the lubricating oil L moving radially outward from the upper surface 41A due to centrifugal force, and suppresses the outflow of the lubricating oil L radially outward from the upper surface 41A. Accordingly, the lubricating oil L adhered to the upper surface 41A readily flows into the through hole 42A of the support shaft 42.

As the support shaft 42 rotates together with the main body 41, the lubricating oil L adhered to the inner circumferential surface 42B of the support shaft 42 is subjected to a centrifugal force acting radially outward of the planetary carrier 39. The centrifugal force causes the lubricating oil L to move radially outward of the planetary carrier 39 on the inner circumferential surface 42B of the support shaft 42.

As shown in FIGS. 6 and 7, the oil guide portion 47 is provided on the inner circumferential surface 42B of the through hole 42A of the support shaft 42. The oil guide portion 47 includes the oil catch portion 47A and the helical groove 47B. Further, the support shaft 42 includes an oil discharge hole 42D formed in a radially outer portion of the planetary carrier 39.

On the inner circumferential surface 42B of the through hole 42A, the oil catch portion 47A protrudes radially inward at the upper end thereof and extends in the circumferential direction. On the inner circumferential surface 42B of the through hole 42A, the oil catch portion 47A is formed at the radially outer portion of the planetary carrier 39. The oil catch portion 47A is an oil blocking portion that can block the lubricating oil L attempting to flow upward from the through hole 42A and suppress the outflow of the lubricating oil L from the through hole 42A. Accordingly, the oil catch portion 47A can retain the lubricating oil L within the through hole 42A, thereby allowing the lubricating oil L to readily flow into the oil discharge hole 42D.

On the inner circumferential surface 42B of the through hole 42A, the helical groove 47B extends helically about the central axis of the through hole 42A from the upper end on the main body 41 side to the oil discharge hole 42D. On the inner circumferential surface 42B of the through hole 42A, oil droplets of the lubricating oil L that have moved into the helical groove 47B tend to remain in the helical groove 47B. Accordingly, in the helical groove 47B, a plurality of oil droplets of the lubricating oil L tends to gather and coalesce. As the plurality of oil droplets coalesces and the size of the oil droplets increases, the oil droplets are facilitated to move toward the oil discharge hole 42D. Further, since the helical groove 47B extends to the oil discharge hole 42D, the helical groove 47B can guide the oil droplets of the lubricating oil L to the oil discharge hole 42D. Accordingly, the helical groove 47B facilitates the coalescence of the plurality of oil droplets and guides the lubricating oil L to the oil discharge hole 42D, thereby allowing the lubricating oil L to readily flow into the oil discharge hole 42D. As described above, the oil catch portion 47A and the helical groove 47B of the oil guide portion 47 guide the lubricating oil L that flows into the through hole 42A to the oil discharge hole 42D.

The lubricating oil L that flows into the oil discharge hole 42D flows out into the oil introduction hole 54 of the bearing 43, and further flows out from the oil introduction hole 54 into the space between the inner ring 51 (the first single-row inner ring 51A and the second single-row inner ring 51B) and the outer ring 52 (the first single-row outer ring 52A and the second single-row outer ring 52B).

In the space between the first single-row inner ring 51A and the first single-row outer ring 52A, the lubricating oil L adheres to the first tapered roller 53A. The first rotation axis of the first tapered roller 53A is inclined radially outward of the support shaft 42 from one end of the first tapered roller 53A on the oil introduction hole 54 side to the other end thereof. The lubricating oil L flows along the outer circumferential surface of the first tapered roller 53A, and thus flows radially outward of the support shaft 42. Accordingly, the lubricating oil L flows readily along the outer circumferential surface of the first tapered roller 53A due to centrifugal force acting radially outward of the support shaft 42.

Then, due to centrifugal force, the lubricating oil L moves radially outward of the support shaft 42 along the outer circumferential surface of the first tapered roller 53A and flows out from the upper side of the bearing 43. As a result, the first bearing 43A (the first single-row inner ring 51A, the outer ring 52, and the first tapered roller 53A) is lubricated. Further, the lubricating oil L that flows out from the upper side of the bearing 43 flows radially outward of the planetary gear 37 from the upper surface 41A of the planetary gear 37, and flows into the gap between the planetary gear 37 and the sun gear 36 and the gap between the planetary gear 37 and the ring gear 38, thereby providing lubrication.

In the space between the second single-row inner ring 51B and the outer ring 52, the lubricating oil L adheres to the second tapered roller 53B. The second rotation axis of the second tapered roller 53B is inclined radially outward of the support shaft 42 from one end of the second tapered roller 53B on the oil introduction hole 54 side to the other end thereof. The lubricating oil L flows along the outer circumferential surface of the second tapered roller 53B, and thus flows radially outward of the support shaft 42. Accordingly, the lubricating oil L flows readily along the outer circumferential surface of the second tapered roller 53B due to the centrifugal force acting radially outward of the support shaft 42. Then, due to centrifugal force, the lubricating oil L moves radially outward of the support shaft 42 along the outer circumferential surface of the second tapered roller 53B and flows out from the lower side of the bearing 43. As a result, the second bearing 43B (the second single-row inner ring 51B, the outer ring 52, and the second tapered roller 53B) is lubricated.

Next, the effects of the reduction gear 19 will be described.

The support shaft 42 includes the through hole 42A penetrating the planetary carrier 39, the oil discharge hole 42D extending from the inner circumferential surface 42B of the through hole 42A to the outer circumferential surface of the support shaft 42, and the oil guide portion 47 provided on the inner circumferential surface 42B of the through hole 42A and configured to guide the lubricating oil L that flows into the through hole 42A to the oil discharge hole 42D.

The lubricating oil L that flows into the through hole 42A is guided to the oil discharge hole 42D by the oil guide portion 47, flows through the oil discharge hole 42D and the oil introduction hole 54 of the bearing 43, and flows out into the space between the inner ring 51 and the outer ring 52 of the bearing 43. Accordingly, the bearing 43 is lubricated by the lubricating oil L. Here, the oil guide portion 47 guides the lubricating oil L to the oil discharge hole 42D, so that the lubricating oil L that flows into the through hole 42A can readily flow into the oil discharge hole 42D. This allows the gap between the planetary carrier 39 and the planetary gear 37 to be easily lubricated by the lubricating oil L. Accordingly, it is possible to provide the planetary gear mechanism 19 in which the gap between the planetary carrier 39 and the planetary gear 37 can be easily lubricated by the lubricating oil L.

The oil guide portion 47 is provided in the tubular member 46. Accordingly, as shown in FIG. 5, after the oil guide portion 47 is provided in the tubular member 46, the tubular member 46 can be attached to the support shaft main body 45 (the support shaft 42). By forming the support shaft 42 in this manner, it becomes easy to provide the oil guide portion 47. Consequently, it is easy to provide the oil guide portion 47 by the tubular member 46.

The oil guide portion 47 includes the helical groove 47B. The oil droplets of the lubricating oil L adhered to the inner circumferential surface 42B of the through hole 42A tend to remain in the helical groove 47B. Accordingly, in the helical groove 47B, the plurality of oil droplets of the lubricating oil L tends to gather and coalesce. As the plurality of oil droplets coalesces and the size of the oil droplets increases, the oil droplets are facilitated to move toward the oil discharge hole 42D. Further, since the helical groove 47B extends to the oil discharge hole 42D, the helical groove 47B can guide the oil droplets of the lubricating oil L to the oil discharge hole 42D. Accordingly, the helical groove 47B facilitates the coalescence of the plurality of oil droplets and guides the lubricating oil L to the oil discharge hole 42D, thereby allowing the lubricating oil L to readily flow into the oil discharge hole 42D.

The oil guide portion 47 includes the oil catch portion 47A. The oil catch portion 47A can block the lubricating oil L attempting to flow out from the through hole 42A and suppress the outflow of the lubricating oil L from the through hole 42A. Accordingly, the oil catch portion 47A can retain the lubricating oil L within the through hole 42A, thereby allowing the lubricating oil L to readily flow into the oil discharge hole 42D.

The oil introduction hole 54 is formed between the first single-row inner ring 51A and the second single-row inner ring 51B. By forming the oil introduction hole 54 between the first single-row inner ring 51A and the second single-row inner ring 51B, it becomes easy to provide the oil introduction hole 54.

The first rolling element corresponding to the first single-row inner ring 51A is a first tapered roller 53A configured to rotate about the first rotation axis that is inclined radially outward of the support shaft 42 from one end of the first rolling element on the oil introduction hole 54 side to the other end. The second rolling element corresponding to the second single-row inner ring 51B is a second tapered roller 53B configured to rotate about the second rotation axis that is inclined radially outward of the support shaft 42 from one end of the second rolling element on the oil introduction hole 54 side toward the other end.

The lubricating oil L flowing through the oil introduction hole 54 is subjected to centrifugal force acting radially outward of the support shaft 42. The first rotation axis is inclined radially outward of the support shaft 42 from one end of the first tapered roller 53A on the oil introduction hole 54 side to the other end thereof. The lubricating oil L flows along the outer circumferential surface of the first tapered roller 53A, and thus flows radially outward of the support shaft 42. Accordingly, the lubricating oil L flows readily along the outer circumferential surface of the first tapered roller 53A due to the centrifugal force acting radially outward of the support shaft 42. The second rotation axis is inclined radially outward of the support shaft 42 from one end of the second tapered roller 53B on the oil introduction hole 54 side to the other end thereof. The lubricating oil L flows along the outer circumferential surface of the second tapered roller 53B, and thus flows radially outward of the support shaft 42. Accordingly, the lubricating oil L flows readily along the outer circumferential surface of the second tapered roller 53B due to the centrifugal force acting radially outward of the support shaft 42. Accordingly, the lubricating oil L can readily flow along the outer peripheries of the first tapered roller 53A and the second tapered roller 53B. That is, the bearing 43 can be easily lubricated by the lubricating oil L.

The main body 41 includes the inclined surface 41B. The lubricating oil L readily flows into the through hole 42A of the support shaft 42 along the inclined surface 41B due to the inclination of the inclined surface 41B. Accordingly, the lubricating oil L adhered to the upper surface 41A readily flows into the through hole 42A of the support shaft 42.

The main body 41 includes the circumferential wall 41C. The circumferential wall 41C blocks the lubricating oil L moving radially outward from the upper surface 41A due to centrifugal force and suppresses the outflow of the lubricating oil L radially outward from the upper surface 41A. Accordingly, the lubricating oil L adhered to the upper surface 41A readily flows into the through hole 42A of the support shaft 42.

### Second Embodiment

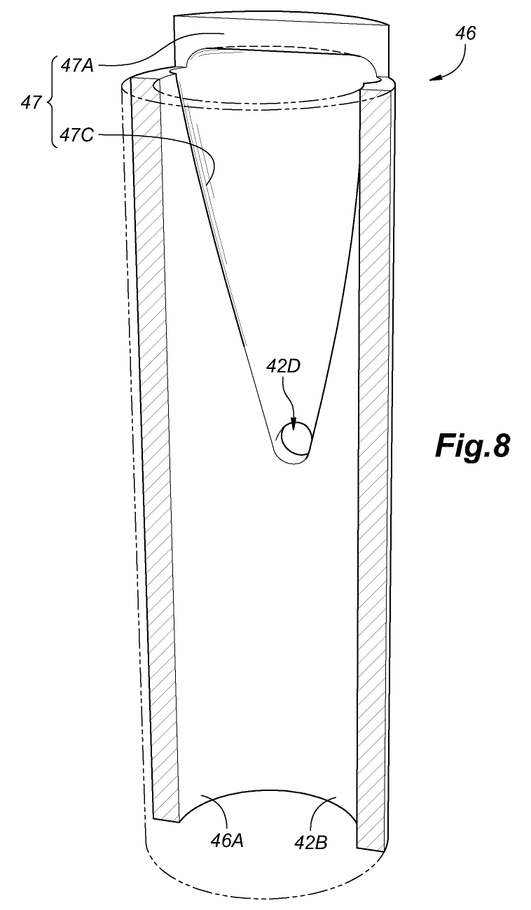

FIG. 8 is a cross-sectional view of the tubular member 46 according to a second embodiment of the present invention. As shown in FIG. 8, the oil guide portion 47 according to the second embodiment includes a tapered groove 47C instead of the helical groove 47B of the oil guide portion 47 according to the first embodiment. In the following descriptions of the second to sixth embodiments, components that are the same as or similar to those of the aircraft 1 according to the first embodiment are given the same reference numerals, and duplicate detailed descriptions will be omitted.

On the inner circumferential surface 42B of the through hole 42A, the tapered groove 47C extends from the upper end (one end) on the main body 41 side to the oil discharge hole 42D and is tapered from the upper end (the one end) on the main body 41 side towards the oil discharge hole 42D.

The oil droplets of the lubricating oil L adhered to the inner circumferential surface 42B of the through hole 42A move to the tapered groove 47C due to centrifugal force and tend to remain in the tapered groove 47C. Further, since the tapered groove 47C is a groove, the oil droplets of the lubricating oil L are unlikely to move out of the tapered groove 47C. As a result, the lubricating oil L is collected in the tapered groove 47C. The extension of the tapered groove 47C to the oil discharge hole 42D facilitates movement of the lubricating oil L within the tapered groove 47C toward the oil discharge hole 42D. Accordingly, the lubricating oil L readily flows into the oil discharge hole 42D. Consequently, the lubricating oil L can readily flow through the oil introduction hole 54, thereby allowing the lubricating oil L to easily lubricate the bearing 43.

### Third Embodiment

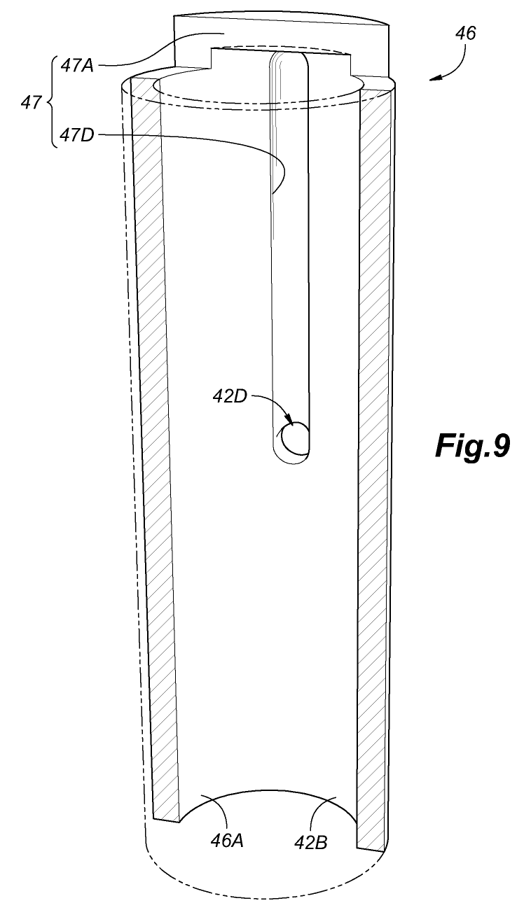

FIG. 9 is a cross-sectional view of the tubular member 46 according to a third embodiment of the present invention. As shown in FIG. 9, the oil guide portion 47 according to the third embodiment includes a linear groove 47D instead of the helical groove 47B of the oil guide portion 47 according to the first embodiment. On the inner circumferential surface 42B of the through hole 42A, the linear groove 47D is formed in the radially outer portion of the planetary carrier 39 and extends linearly along the axial direction of the support shaft 42 from the upper end (one end) on the main body 41 side to the oil discharge hole 42D. The linear groove 47D extends in the axial direction X.

On the inner circumferential surface 42B of the through hole 42A, the linear groove 47D is formed in the radially outer portion of the planetary carrier 39. The oil droplets of the lubricating oil L adhered to the inner circumferential surface 42B of the through hole 42A move to the linear groove 47D due to centrifugal force and tend to remain in the linear groove 47D. Further, since the linear groove 47D is a groove, the oil droplets of the lubricating oil L are unlikely to move out of the linear groove 47D. As a result, the lubricating oil L is collected in the linear groove 47D. The extension of the linear groove D to the oil discharge hole 42D facilitates movement of the lubricating oil L within the linear groove 47D toward the oil discharge hole 42D. Accordingly, the lubricating oil L adhered to the inner circumferential surface 42B of the through hole 42A readily flows into the oil discharge hole 42D by the linear groove 47D. Consequently, the lubricating oil L can readily flow through the oil introduction hole 54, thereby allowing the lubricating oil L to easily lubricate the bearing 43.

### Fourth Embodiment

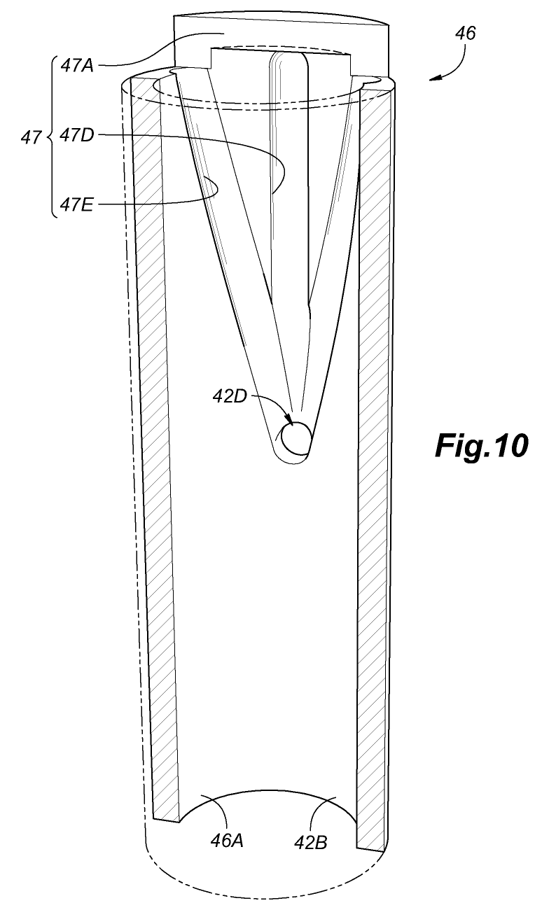

FIG. 10 is a cross-sectional view of the tubular member 46 according to a fourth embodiment of the present invention. As shown in FIG. 10, the oil guide portion 47 according to the fourth embodiment includes the linear groove 47D and a plurality of linear grooves 47E instead of the helical groove 47B of the oil guide portion 47 according to the first embodiment.

On the inner circumferential surface 42B of the through hole 42A, the linear groove 47D is formed in the radially outer portion of the planetary carrier 39 and extends linearly along the axial direction of the support shaft 42 from the upper end (one end) on the main body 41 side to the oil discharge hole 42D. The linear groove 47D extends in the axial direction X. On the inner circumferential surface 42B of the through hole 42A, the plurality of linear grooves 47E extend linearly from the upper end (one end) on the main body 41 side to the oil discharge hole 42D along a direction that intersects the axial direction X of the support shaft 42.

On the inner circumferential surface 42B of the through hole 42A, the linear groove 47D is formed in the radially outer portion of the planetary carrier 39. The oil droplets of the lubricating oil L adhered to the inner circumferential surface 42B of the through hole 42A move to the linear groove 47D due to centrifugal force and tend to remain in the linear groove 47D. The linear groove 47D and the linear grooves 47E are grooves. Accordingly, the oil droplets of the lubricating oil L are unlikely to move out of the linear groove 47D, and the oil droplets of the lubricating oil L are unlikely to move out of the linear grooves 47E. As a result, the lubricating oil L is collected in the linear groove 47D and the linear grooves 47E. The extensions of the tapered groove 47C and the linear grooves 47E to the oil discharge hole 42D facilitate movement of the lubricating oil L within the tapered groove 47C and the linear grooves 47E toward the oil discharge hole 42D. Accordingly, the lubricating oil L adhered to the inner circumferential surface 42B of the through hole 42A readily flows into the oil discharge hole 42D by the linear groove 47D and the linear grooves 47E. Consequently, the lubricating oil L can readily flow through the oil introduction hole 54, thereby allowing the lubricating oil L to easily lubricate the bearing 43.

### Fifth Embodiment

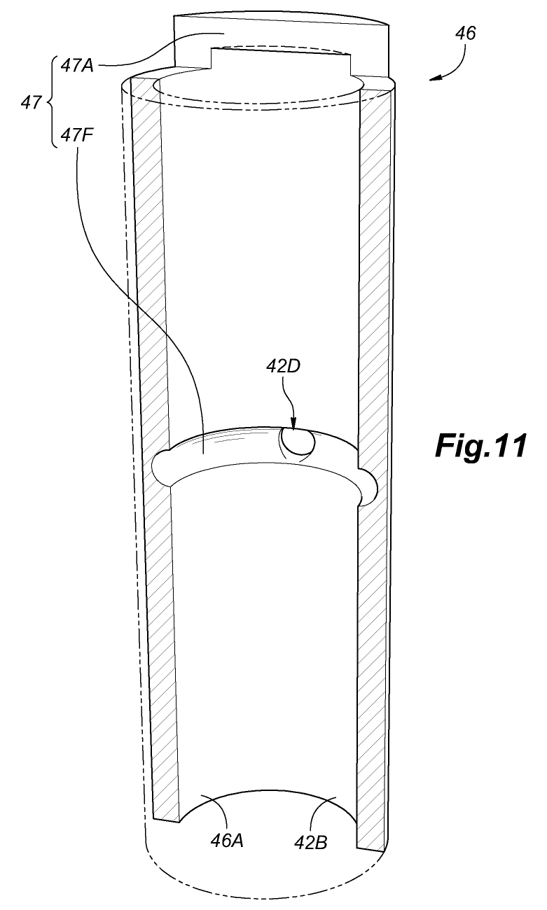

FIG. 11 is a cross-sectional view of the tubular member 46 according to a fifth embodiment of the present invention. As shown in FIG. 11, the oil guide portion 47 according to the fifth embodiment includes a circumferential groove 47F instead of the helical groove 47B of the oil guide portion 47 according to the first embodiment. On the inner circumferential surface 42B of the through hole 42A, the circumferential groove 47F extends in the circumferential direction and passes through the oil discharge hole 42D.

The oil droplets of the lubricating oil L adhered to the inner circumferential surface 42B of the through hole 42A tend to flow downward and collect in the circumferential groove 47F. Since the circumferential groove 47F is a groove, the oil droplets of the lubricating oil L tend to remain in the circumferential groove 47F. The oil droplets of the lubricating oil L retained in the circumferential grooves 47F move toward the oil discharge hole 42D due to centrifugal force, and readily flow into the oil discharge hole 42D. Accordingly, the lubricating oil L adhered to the inner circumferential surface 42B of the through hole 42A readily flows into the oil discharge hole 42D by the circumferential groove 47F. Consequently, the lubricating oil L can readily flow through the oil introduction hole 54, thereby allowing the lubricating oil L to easily lubricate the bearing 43.

### Sixth Embodiment

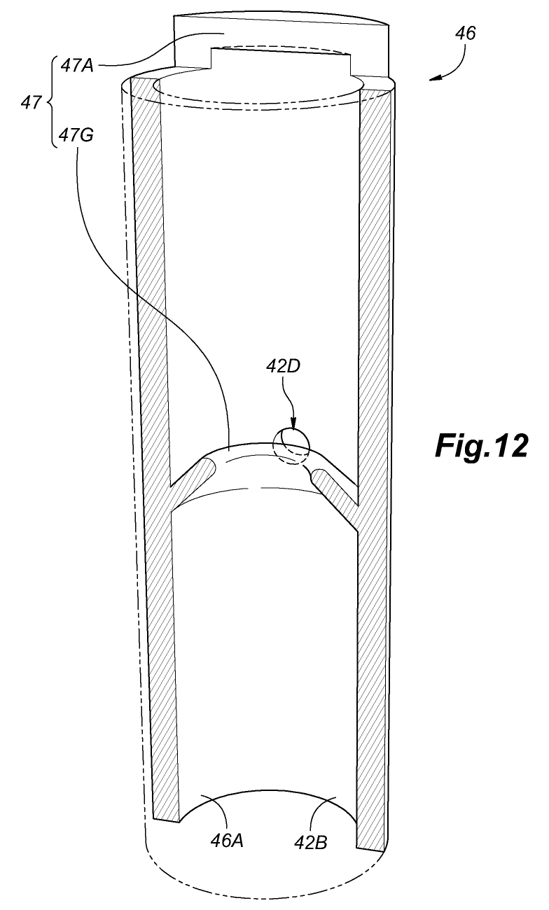

FIG. 12 is a cross-sectional view of the tubular member 46 according to a sixth embodiment of the present invention. As shown in FIG. 12, the oil guide portion 47 of the sixth embodiment includes a circumferential protrusion 47G instead of the helical groove 47B of the oil guide portion 47 according to the first embodiment. On the inner circumferential surface 42B of the through hole 42A, the circumferential protrusion 47G protrudes radially inward below the oil discharge hole 42D (on the side farther from the main body 41 side) and extends in a circumferential direction.

The circumferential protrusion 47G guides the lubricating oil L adhered to the inner circumferential surface 42B of the through hole 42A to the oil discharge hole 42D. Accordingly, the lubricating oil L readily flows into the oil discharge hole 42D by the circumferential protrusion 47G. Consequently, the lubricating oil L can readily flow through the oil introduction hole 54, thereby allowing the lubricating oil L to easily lubricate the bearing 43.

The embodiment is not limited to the above configuration and can be widely modified and implemented. For example, the bearing 43 may be the bearing that does not have the first bearing 43A and the second bearing 43B. The bearing 43 may be, for example, a tapered roller bearing or an angular contact ball bearing. The reduction gear 19 (the planetary gear mechanism) may not include the tubular member 46 having the oil guide portion 47, and the oil guide portion 47 may be provided on the inner circumferential surface of the support shaft main body 45. Further, in the above embodiments, the rotation axes of the output shaft 17, the input shaft 31, the sun gear 36, the planetary gear 37, and the ring gear 38 extend in the up-and-down direction, but may not necessarily extend in the up-and-down direction. For example, the rotation axes of the output shaft 17, the input shaft 31, the sun gear 36, the planetary gear 37, and the ring gear 38 may extend horizontally or obliquely relative to the up-and-down direction.

The above embodiments may also be described as follows.

One embodiment provides a planetary gear mechanism 19 including: a sun gear 36 coupled to an input shaft 31 extending in an axial direction X; a plurality of planetary gears 37 meshed with the sun gear 36; a ring gear 38 supported by a case 15A and meshed with the plurality of planetary gears 37; and a planetary carrier 39 rotatably supporting the plurality of planetary gears 37 and coupled to an output shaft 17 extending coaxially with the input shaft 31. The planetary carrier 39 includes: a main body 41 connected to the output shaft 17; a plurality of support shafts 42 provided on the main body 41 and supporting the plurality of planetary gears 37; and a bearing 43 provided between each of the plurality of support shafts 42 and the corresponding planetary gear 37. The bearing 43 includes: at least one inner ring 51 fixed to the support shaft 42; an outer ring 52 fixed to the planetary gear 37; a plurality of rolling elements 53A and 53B arranged between the inner ring 51 and the outer ring 52; and an oil introduction hole 54 penetrating the inner ring 51 in a radial direction of the support shaft 42. Each of the plurality of support shafts 42 includes: a through hole 42A penetrating the planetary carrier 39 along an axis of the support shaft 42; an oil discharge hole 42D formed in a radially outer portion of the planetary carrier 39 and extending from an inner circumferential surface 42B of the through hole 42A to an outer circumferential surface 42C of the support shaft 42; and an oil guide portion 47 provided on the inner circumferential surface 42B of the through hole 42A and configured to guide a lubricating oil L that flows into the through hole 42A to the oil discharge hole 42D.

According to this aspect, the lubricating oil L that flows into the through hole 42A is guided to the oil discharge hole 42D by the oil guide portion 47, flows through the oil discharge hole 42D and the oil introduction hole 54 of the bearing 43, and flows out into the space between the inner ring 51 and the outer ring 52 of the bearing 43. Accordingly, the bearing 43 is lubricated by the lubricating oil L. Here, the oil guide portion 47 guides the lubricating oil L to the oil discharge hole 42D, so that the lubricating oil L that flows into the through hole 42A can readily flow into the oil discharge hole 42D. This allows the gap between the planetary carrier 39 and the planetary gear 37 to be easily lubricated by the lubricating oil L. Accordingly, it is possible to provide the planetary gear mechanism 19 in which the gap between the planetary carrier 39 and the planetary gear 37 can be easily lubricated by the lubricating oil L.

In one embodiment, the support shaft 42 includes a tubular member 46 defining the through hole 42A by an inner circumferential surface 46A, and the oil guide portion 47 is provided in the tubular member 46.

According to this aspect, after the oil guide portion 47 is provided in the tubular member 46, the tubular member 46 can be attached to the support shaft main body 45 (the support shaft 42). By forming the support shaft 42 in this manner, it becomes easy to provide the oil guide portion 47. Consequently, it is easy to provide the oil guide portion 47 by the tubular member 46.

In one embodiment, the oil guide portion 47 includes, on the inner circumferential surface 42B of the through hole 42A, a helical groove 47B extending helically about a central axis of the through hole 42A from an upper end (one end) on the main body 41 side to the oil discharge hole 42D.

According to this aspect, the oil droplets of the lubricating oil L adhered to the inner circumferential surface 42B of the through hole 42A tend to remain in the helical groove 47B. Accordingly, in the helical groove 47B, the plurality of oil droplets of the lubricating oil L tends to gather and coalesce. As the plurality of oil droplets coalesces and the size of the oil droplets increases, the oil droplets are facilitated to move toward the oil discharge hole 42D. Further, since the helical groove 47B extends to the oil discharge hole 42D, the helical groove 47B can guide the oil droplets of the lubricating oil L to the oil discharge hole 42D. Accordingly, the helical groove 47B facilitates the coalescence of the plurality of oil droplets and guides the lubricating oil L to the oil discharge hole 42D, thereby allowing the lubricating oil L to readily flow into the oil discharge hole 42D.

In one embodiment, the oil guide portion 47 includes, on the inner circumferential surface 42B of the through hole 42A, a tapered groove 47C formed in the radially outer portion of the planetary carrier 39, extending from an upper end (one end) on the main body 41 side to the oil discharge hole 42D, and tapered from the upper end (the one end) on the main body 41 side towards the oil discharge hole 42D.

According to this aspect, the oil droplets of the lubricating oil L adhered to the inner circumferential surface 42B of the through hole 42A are moved to the tapered groove 47C due to centrifugal force and tend to remain in the tapered groove 47C. Further, since the tapered groove 47C is a groove, the oil droplets of the lubricating oil L are unlikely to move out of the tapered groove 47C. As a result, the lubricating oil L is collected in the tapered groove 47C. The extension of the tapered groove 47C to the oil discharge hole 42D facilitates movement of the lubricating oil L within the tapered groove 47C toward the oil discharge hole 42D. Accordingly, the lubricating oil L readily flows into the oil discharge hole 42D. Consequently, the lubricating oil L can readily flow through the oil introduction hole 54, thereby allowing the lubricating oil L to easily lubricate the bearing 43.

In one embodiment, the oil guide portion 47 includes, on the inner circumferential surface 42B of the through hole 42A, a linear groove 47D formed in the radially outer portion of the planetary carrier 39 and extending linearly along an axial direction X of the support shaft 42 from an upper end (one end) on the main body 41 side to the oil discharge hole 42D.

According to this aspect, the linear groove 47D is formed in the radially outer portion of the planetary carrier 39 on the inner circumferential surface 42B of the through hole 42A. The oil droplets of the lubricating oil L adhered to the inner circumferential surface 42B of the through hole 42A move to the linear groove 47D due to centrifugal force and tend to remain in the linear groove 47D. Further, since the linear groove 47D is a groove, the oil droplets of the lubricating oil L are unlikely to move out of the linear groove 47D. As a result, the lubricating oil L is collected in the linear groove 47D. The extension of the linear groove 47D to the oil discharge hole 42D facilitates movement of the lubricating oil L within the linear groove 47D toward the oil discharge hole 42D. Accordingly, the lubricating oil L adhered to the inner circumferential surface 42B of the through hole 42A readily flows into the oil discharge hole 42D by the linear groove 47D. Consequently, the lubricating oil L can readily flow through the oil introduction hole 54, thereby allowing the lubricating oil L to easily lubricate the bearing 43.

In one embodiment, the oil guide portion 47 includes a circumferential groove 47F extending in a circumferential direction on the inner circumferential surface 42B of the through hole 42A and passing through the oil discharge hole 42D.

According to this aspect, the oil droplets of the lubricating oil L adhered to the inner circumferential surface 42B of the through hole 42A tend to flow downward and collect in the circumferential groove 47F. Since the circumferential groove 47F is a groove, the oil droplets of the lubricating oil L tend to remain in the circumferential groove 47F. Then, the oil droplets of the lubricating oil L retained in the circumferential grooves 47F move toward the oil discharge hole 42D due to centrifugal force, and readily flow into the oil discharge hole 42D. Accordingly, the lubricating oil L adhered to the inner circumferential surface 42B of the through hole 42A readily flows into the oil discharge hole 42D by the circumferential groove 47F. Consequently, the lubricating oil L can readily flow through the oil introduction hole 54, thereby allowing the lubricating oil L to easily lubricate the bearing 43.

In one embodiment, the oil guide portion 47 includes, on the inner circumferential surface 42B of the through hole 42A, a circumferential protrusion 47G protruding radially inward on a side farther from the main body 41 side than the oil discharge hole 42D and extending in a circumferential direction.

According to this aspect, the circumferential protrusion 47G guides the lubricating oil L adhered to the inner circumferential surface 42B of the through hole 42A to the oil discharge hole 42D. Accordingly, the lubricating oil L readily flows into the oil discharge hole 42D by the circumferential protrusion 47G. Consequently, the lubricating oil L can readily flow through the oil introduction hole 54, thereby allowing the lubricating oil L to easily lubricate the bearing 43.

In one embodiment, the oil guide portion 47 includes, on the inner circumferential surface 42B of the through hole 42A, an oil catch portion 47A formed in the radially outer portion of the planetary carrier 39, protruding radially inward at an upper end (one end) on the main body 41 side, and extending in a circumferential direction.

According to this aspect, the oil catch portion 47A can block the lubricating oil L attempting to flow out from the through hole 42A and suppress the outflow of the lubricating oil L from the through hole 42A. Accordingly, the oil catch portion 47A can retain the lubricating oil L within the through hole 42A, thereby allowing the lubricating oil L to readily flow into the oil discharge hole 42D.

In one embodiment, the at least one inner ring 51 comprises a plurality of inner rings 51, the bearing 43 includes: as the inner rings 51, a first single-row inner ring 51A and a second single-row inner ring 51B that are fixed to the support shaft 42 and aligned in the axial direction X; and as the rolling elements 53, a plurality of first rolling elements 53A arranged between the first single-row inner ring 51A and the outer ring 52, and a plurality of second rolling elements 53B arranged between the second single-row inner ring 51B and the outer ring 52, and the oil introduction hole 54 is formed between the first single-row inner ring 51A and the second single-row inner ring 51B.

According to this aspect, by forming the oil introduction hole 54 between the first single-row inner ring 51A and the second single-row inner ring 51B, it becomes easy to provide the oil introduction hole 54.

In one embodiment, the first single-row inner ring 51A is arranged on the main body 41 side of the second single-row inner ring 51B, each of the plurality of first rolling elements 53A is a first tapered roller 53A configured to rotate about a first rotation axis that is inclined radially outward of the support shaft 42 from a lower end (one end) of the first rolling element 53A on the oil introduction hole 54 side to an upper end (the other) end, and each of the plurality of second rolling elements 53B is a second tapered roller 53B configured to rotate about a second rotation axis that is inclined radially outward of the support shaft 42 from the upper end (one end) of the second rolling element 53B on the oil introduction hole 54 side to the lower end (the other end).

In this embodiment, the lubricating oil L flowing through the oil introduction hole 54 is subjected to centrifugal force acting radially outward of the support shaft 42. The first rotation axis is inclined radially outward of the support shaft 42 from the lower end (one end) of the first tapered roller 53A on the oil introduction hole 54 side to the upper end (the other end) thereof. The lubricating oil L flows along the outer circumferential surface of the first tapered roller 53A, and thus flows radially outward of the support shaft 42. Accordingly, the lubricating oil L flows readily along the outer circumferential surface of the first tapered roller 53A due to centrifugal force acting radially outward from the support shaft 42. The second rotation axis is inclined radially outward of the support shaft 42 from the upper end (one end) of the second tapered roller 53B on the oil introduction hole 54 side to the lower end (the other end) thereof. The lubricating oil L flows along the outer circumferential surface of the second tapered roller 53B, and thus flows radially outward of the support shaft 42. Accordingly, the lubricating oil L flows readily along the outer circumferential surface of the second tapered roller 53B due to centrifugal force acting radially outward of the support shaft 42. Accordingly, the lubricating oil L can readily flow along the outer peripheries of the first tapered roller 53A and the second tapered roller 53B. That is, the bearing 43 can be easily lubricated by the lubricating oil L.

In one embodiment, the main body 41 of the planetary carrier 39 is formed in a disk shape extending radially about the output shaft 17, and includes an inclined surface 41B inclined toward the support shaft 42 in a circumferential direction and inclined from the upper side (from the main body 41 side) toward the lower side (an opposite side) of the support shaft 42.

According to this aspect, the lubricating oil L readily flows into the through hole 42A of the support shaft 42 along the inclined surface 41B due to the inclination of the inclined surface 41B. Accordingly, the lubricating oil L adhered to the upper surface 41A readily flows into the through hole 42A of the support shaft 42.

In one embodiment, the main body 41 of the planetary carrier 39 is formed in a disk shape extending radially about the output shaft 17, and includes a circumferential wall 41C protruding downward (to an opposite side of the support shaft 42) at a radially outer end thereof and extending in a circumferential direction.

According to this aspect, the circumferential wall 41C blocks the lubricating oil L moving radially outward from the upper surface 41A due to centrifugal force, and suppresses the outflow of the lubricating oil L radially outward from the upper surface 41A. Accordingly, the lubricating oil L adhered to the upper surface 41A readily flows into the through hole 42A of the support shaft 42.

1. A planetary gear mechanism comprising:
a sun gear coupled to an input shaft extending in an axial direction;
a plurality of planetary gears meshed with the sun gear;
a ring gear supported by a case and meshed with the plurality of planetary gears; and
a planetary carrier rotatably supporting the plurality of planetary gears and coupled to an output shaft extending coaxially with the input shaft, wherein
the planetary carrier includes:
a main body connected to the output shaft;
a plurality of support shafts provided on the main body and supporting the plurality of planetary gears; and
a bearing provided between each of the plurality of support shafts and the corresponding planetary gear,
the bearing includes:
at least one inner ring fixed to the support shaft;
an outer ring fixed to the planetary gear;
a plurality of rolling elements arranged between the inner ring and the outer ring; and
an oil introduction hole penetrating the inner ring in a radial direction of the support shaft, and
each of the plurality of support shafts includes:
a through hole penetrating the planetary carrier along an axis of the support shaft;
an oil discharge hole formed in a radially outer portion of the planetary carrier and extending from an inner circumferential surface of the through hole to an outer circumferential surface of the support shaft; and
an oil guide portion provided on the inner circumferential surface of the through hole and configured to guide a lubricating oil that flows into the through hole to the oil discharge hole.

2. The planetary gear mechanism according to claim 1, wherein the support shaft includes a tubular member defining the through hole, and
the oil guide portion is provided in the tubular member.

3. The planetary gear mechanism according to claim 1, wherein the oil guide portion includes, on the inner circumferential surface of the through hole, a helical groove extending helically about a central axis of the through hole from one end on the main body side to the oil discharge hole.

4. The planetary gear mechanism according to claim 1, wherein the oil guide portion includes, on the inner circumferential surface of the through hole, a tapered groove formed in the radially outer portion of the planetary carrier, extending from one end on the main body side to the oil discharge hole, and tapered from the one end on the main body side towards the oil discharge hole.

5. The planetary gear mechanism according to claim 1, wherein the oil guide portion includes, on the inner circumferential surface of the through hole, a linear groove formed in the radially outer portion of the planetary carrier and extending linearly along an axial direction of the support shaft from one end on the main body side to the oil discharge hole.

6. The planetary gear mechanism according to claim 1, wherein the oil guide portion includes a circumferential groove extending in a circumferential direction on the inner circumferential surface of the through hole and passing through the oil discharge hole.

7. The planetary gear mechanism according to claim 1, wherein the oil guide portion includes, on the inner circumferential surface of the through hole, a circumferential protrusion protruding radially inward on a side farther from the main body side than the oil discharge hole and extending in a circumferential direction.

8. The planetary gear mechanism according to claim 1, wherein the oil guide portion includes, on the inner circumferential surface of the through hole, an oil catch portion formed in the radially outer portion of the planetary carrier, protruding radially inward at one end on the main body side, and extending in a circumferential direction.

9. The planetary gear mechanism according to claim 1, wherein the at least one inner ring comprises a plurality of inner rings,
the bearing includes:
as the inner rings, a first single-row inner ring and a second single-row inner ring that are fixed to the support shaft and aligned in the axial direction; and
as the rolling elements, a plurality of first rolling elements arranged between the first single-row inner ring and the outer ring, and a plurality of second rolling elements arranged between the second single-row inner ring and the outer ring, and
the oil introduction hole is formed between the first single-row inner ring and the second single-row inner ring.

10. The planetary gear mechanism according to claim 9, wherein the first single-row inner ring is arranged on the main body side of the second single-row inner ring,
each of the plurality of first rolling elements is a first tapered roller configured to rotate about a first rotation axis that is inclined radially outward of the support shaft from one end of the first rolling element on the oil introduction hole side to the other end, and
each of the plurality of second rolling elements is a second tapered roller configured to rotate about a second rotation axis that is inclined radially outward of the support shaft from one end of the second rolling element on the oil introduction hole side to the other end.

11. The planetary gear mechanism according to claim 1, wherein the main body of the planetary carrier is formed in a disk shape extending radially about the output shaft, and includes an inclined surface inclined toward the support shaft in a circumferential direction and inclined from the main body side toward an opposite side of the support shaft.

12. The planetary gear mechanism according to claim 1, wherein the main body of the planetary carrier is formed in a disk shape extending radially about the output shaft, and includes a circumferential wall protruding to an opposite side of the support shaft at a radially outer end thereof and extending in a circumferential direction.
